(19) United States
(12) Patent Application Publication
(10) Pub. No.: US 2018/0218468 A1
(43) Pub. Date: Aug. 2, 2018

(54) MENTOR-PROTÉGÉ MATCHING SYSTEM AND METHOD

(71) Applicant: INTERNATIONAL BUSINESS MACHINES CORPORATION, Armonk, NY (US)

(72) Inventors: Jonathan Dunne, Dungarvan (IE); Amy D. Travis, Arlington, MA (US)

(21) Appl. No.: 15/421,299

(22) Filed: Jan. 31, 2017

(51) Int. Cl. G06Q 50/20; G06N 7/00

(52) U.S. Cl. CPC G06Q 50/2057; G06N 7/005

(57) ABSTRACT

A novel mentor-mentee matching system that uses statistics on collaborative involvement to identify suitable mentor-mentee pairing is disclosed. The mentor-mentee matching system receives collaboration data about one or more prospective mentors over one or more subject areas. The system computes a survival quotient for a prospective mentor in a particular subject area by aggregating data relating to longevity of involvement by the prospective mentor in the particular subject area. The system predicts a probability of mentoring relationship survival for a future time interval for the prospective mentor over the particular subject area based on the received collaboration data and the computed survival quotient.

### BACKGROUND

### Technical Field

The present disclosure generally relates to identifying suitable mentors for protégés based on statistical analysis.

### Description of the Related Art

Mentoring is a process for transmission of knowledge, social capital, and the psycho-social support perceived by a recipient as relevant to work, career, or professional development; mentoring entails informal communication, usually face-to-face and during a sustained period of time, between a person who is perceived to have greater relevant knowledge, wisdom, or experience (the mentor) and a person who is perceived to have less (the mentee or protégé).

### SUMMARY

Some of embodiments of the disclosure provide a mentor-mentee matching system. The mentor-mentee matching system receives collaboration data about one or more prospective mentors over one or more subject areas. The system computes a survival quotient for a prospective mentor in a particular subject area by aggregating data relating to longevity of involvement by the prospective mentor in the particular subject area. The system predicts a probability of mentoring relationship survival for a future time interval for the prospective mentor over the particular subject area based on the collected collaboration data and the computed survival quotient.

In some embodiments, the mentor-mentee matching system computes a survival quotient for each of a plurality of prospective mentors in each of a plurality of subject areas. The system predicts a probability of mentoring relationship survival for the future time interval for each of the plurality of prospective mentors over each of the plurality of subject areas. The system then selects a mentor from the plurality of prospective mentors based on the predicted probabilities of mentoring relationship survival.

The preceding Summary is intended to serve as a brief introduction to some embodiments of the disclosure. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a Summary, Detailed Description and the Drawings are provided. Moreover, the claimed subject matter is not to be limited by the illustrative details in the Summary, Detailed Description, and the Drawings, but rather is to be defined by the appended claims, because the claimed subject matter can be embodied in other specific forms without departing from the spirit of the subj ect matter.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example mentor-mentee matching system that identifies suitable mentor-mentee pairings by predicting relationship strengths based on collaboration data.

FIG. 2 illustrates an example content of the collaboration data.

FIG. 3 conceptually illustrates computation of survival quotients, consistent with an exemplary embodiment. Survival quotients are periodic (e.g., yearly) roundup values,

FIG. 4 illustrates a longevity prediction module using a prediction model to predict the probability of survival for a mentoring relationship.

FIG. 5a-b conceptually illustrates using collaboration data and survival quotient of a present time to predict probability of mentoring relationship survival in the future year.

FIG. 6 conceptually illustrates a process for predicting the probability of mentoring relationship survival with respect to subject areas of expertise, consistent with an exemplary embodiment.

FIG. 7 conceptually illustrates a process for matching a mentor with a protégé based on predicted probabilities of relationship survival in different subject areas of expertise, consistent with an exemplary embodiment.

FIG. 8 conceptually illustrates a process for monitoring mentor-mentee relationship deterioration by re-evaluating survival quotients at regular intervals.

FIG. 9 shows a block diagram of the components of a data processing system in accordance with an illustrative embodiment of the present disclosure.

FIG. 10 illustrates an example cloud-computing environment.

FIG. 11 illustrates a set of functional abstraction layers provided by a cloud-computing environment, consistent with an exemplary embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

One of the difficulties with large organizations is their ability to disseminate and share knowledge from subject matter experts to aspiring junior team members. There are existing methods used by organizations attempting to link mentors and protégés (or mentees) together to grow both sets of individuals. These pairing approaches generally focus on identifying union of interest, such as by social tagging and calculating likes and dislikes. The challenge of these ad hoc pairing approaches is that the personality or the background of the individual(s) may not be known before hand. The mentor-mentee relationship may be valuable for both individuals initially, but then fizzles out due to poor matching of interests, personalities, areas of expertise, or other issues.

Some embodiments of the disclosure provide a system and an apparatus aims to generate high value mentor-mentee relationships by identifying common interests as well as by predicting relationship strengths. Specifically, the system analyzes existing collaboration data (e.g., social, meeting, workflow data) for prospective mentors. The system performs statistical analysis on the existing collaboration data to derive survival quotients by aggregating data related to collaborative involvement. A survival quotient measures the longevity of a prospective mentor's collaborative involvement in a particular subject area, which is used as a metric for predicting the strength or longevity of a future mentor-mentee relationship in the particular subject area. The system uses the survival quotient for each existing core areas of expertise to identify potential mentor-mentee pairing with high probability of longevity. In some embodiments, the system also monitors updated collaboration data for mentor-mentee relationship deterioration by re-evaluating survival quotients at regular intervals.

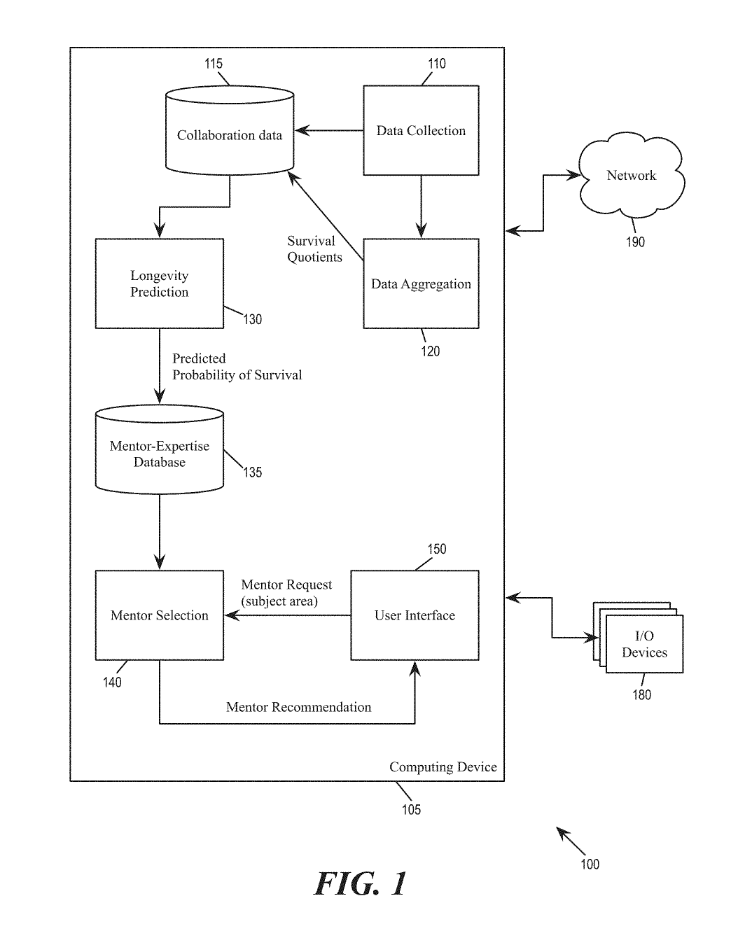

For some embodiments, FIG. 1 illustrates an example mentor-mentee matching system 100 that identifies suitable mentor-mentee pairings by predicting relationship strengths based on collaboration data. The system computes survival quotients of collaborative involvement by prospective mentors in various subject areas. The system then uses the computed survival quotients to predict the strength or longevity of a future mentor-mentee relationship.

As illustrated, a computing device 105 implements the mentor-mentee matching system 100. The computing device 105 receives data and control from a network 190 and a set of input/output (I/O) devices 180. The computing device 105 implements a data collection module 110, a data aggregation module 120, a longevity prediction module 130, a mentor selection module 140, and a user interface 150. In some embodiments, the modules 110-150 are modules of software instructions being executed by one or more processing units (e.g., a processor) of the computing device 105. In some embodiments, the modules 110-150 are modules of hardware circuits implemented by one or more integrated circuits (ICs). Though the modules 110, 120, 130, 140, and 150 are illustrated as being separate modules, some of the modules can be combined into a single module. For example, the functionalities of the data aggregation module 120 can be merged into the data collection module 110 to form one data collection and compilation module.

The data collection module 110 collects raw data that are useful for identifying suitable mentors. Examples of the raw data may include various records of activities within the organization that employs the prospective mentors, research papers or patents submitted, and tasks undertaken and completed, etc. The collected data may include records that track a prospective mentor's activities or tasks regarding a particular subject matter over time, which can be indicative of each prospective mentor's level of interest, commitment, and involvement in a given subject area of expertise. At least some of the raw data relates to collaborative efforts performed over collaborative mediums.

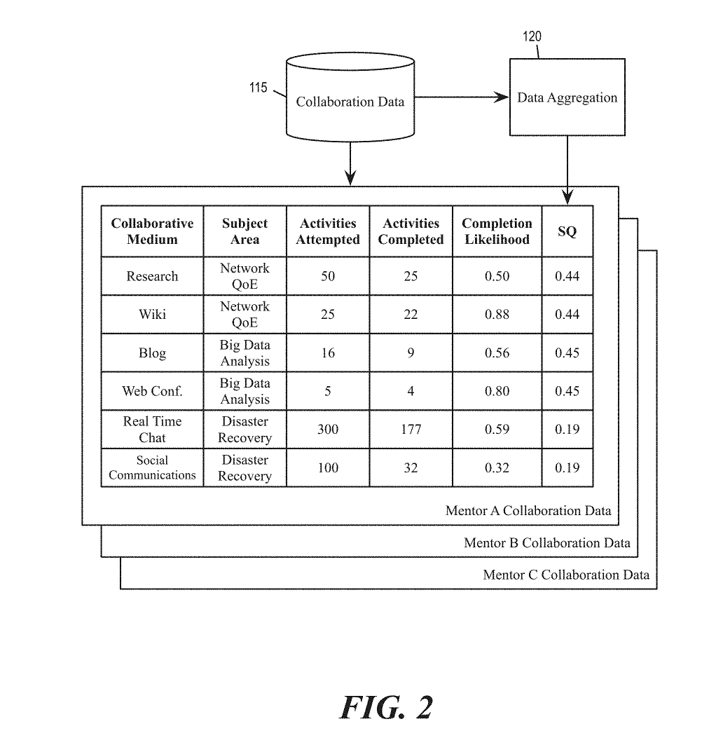

The data collection module 110 may receive the raw data directly from the I/O devices 180, or by crawling the network 190 and the Internet for data regarding prospective mentors. The data collection module 110 compiles the collected raw data into collaboration data 115 about the prospective mentors over various subject areas of expertise. FIG. 2 below illustrates an example content of the collaboration data.

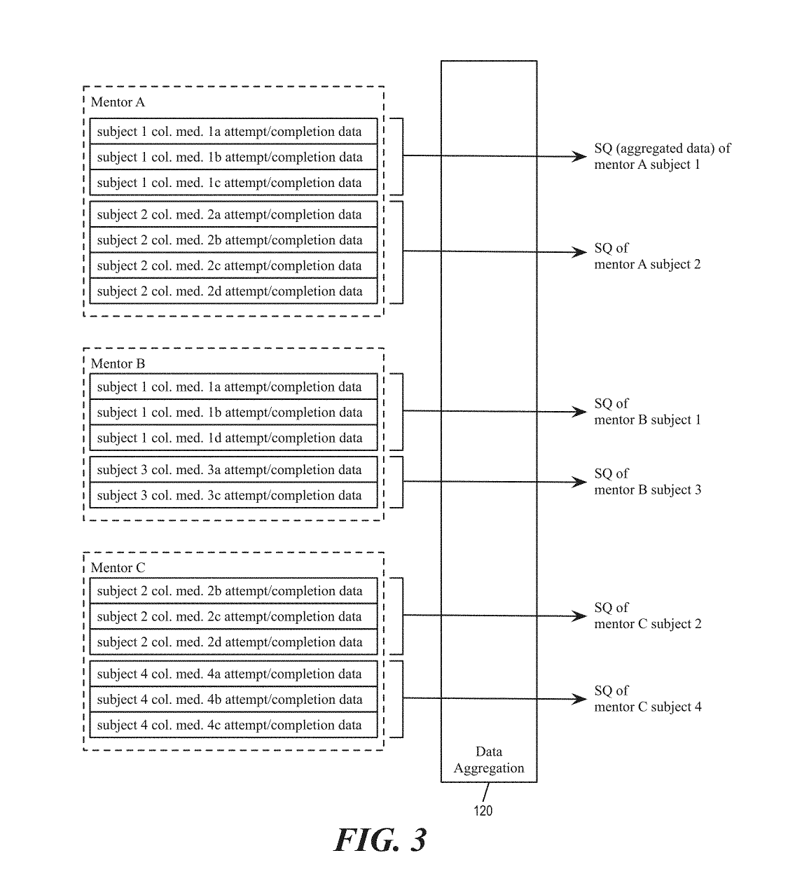

The data aggregation module 120 performs numerical aggregation of the data collected by the data collection module 110. Based on the numerical aggregation, the data aggregation module produces a survival quotient for each prospective mentor over each subject area of expertise. The survival quotient of a prospective mentor for a subject area is a metric that estimates the longevity of the prospective mentor's collaborative involvement in the subject area. The computation of survival quotients will be described further below by reference to FIG. 3 below.

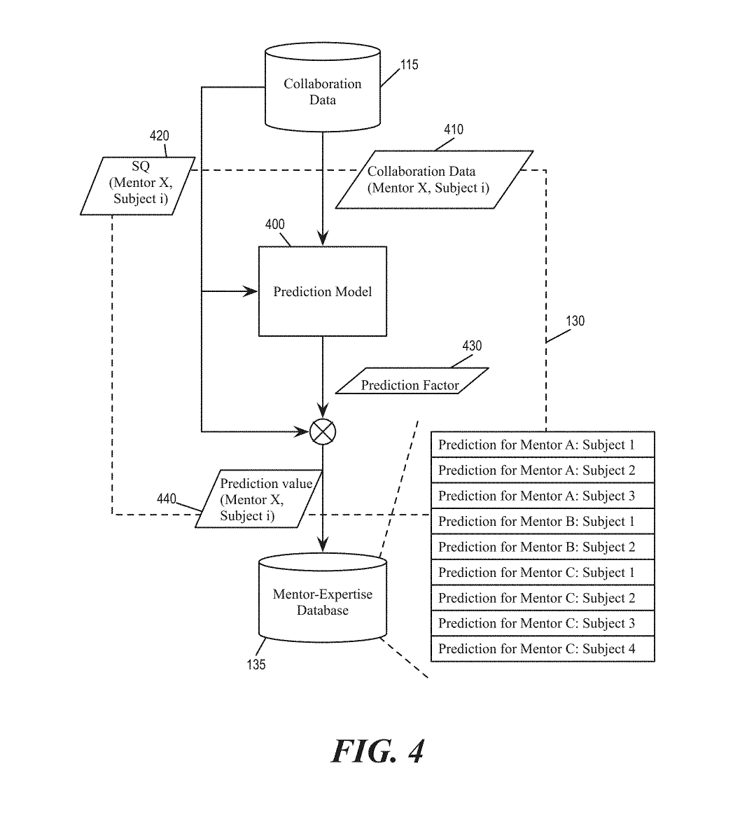

The longevity prediction module 130 uses the collaboration data 115 compiled by the data collection module 110 and the survival quotients provided by the data aggregation module 120 to predict the longevities of mentoring relationships. Specifically, the longevity prediction module 130 produces a prediction value for a mentoring relationship involving a prospective mentor in a particular subject area by applying a prediction model based on the collaboration data and the survival quotient of the prospective mentor in the particular subject area. The prediction value is the probability of the mentoring relationship successfully surviving over a period of time in the future. The prediction of longevity of mentoring relationships will further described below by reference to FIG. 4.

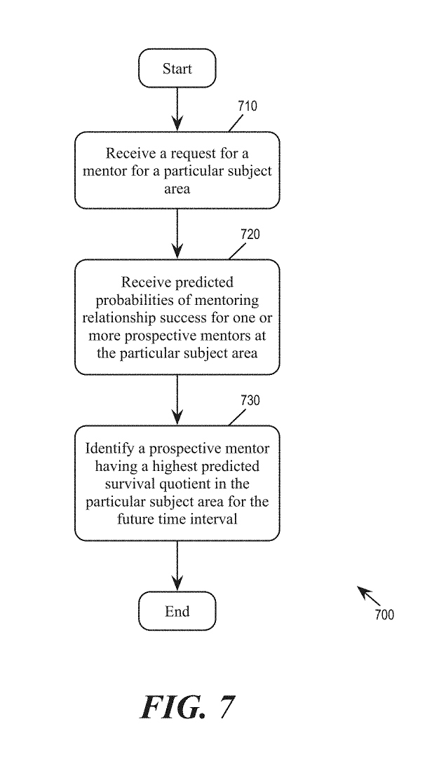

The mentor selection module 140 uses the prediction values produced by the longevity prediction module 130 to match a prospective protégé with a suitable mentor. Specifically, the mentor selection module 140 identifies the suitable mentor by examining which mentor has the best prediction value for a particular subject matter that is of interest to the prospective protégé. In some embodiments, the mentor-mentee matching system 100 stores the prediction values produced by the longevity prediction module 130 in a mentor-expertise database 135, and the mentor selection module 140 look through the database 135 to identify a prospective mentor that has a best prediction value in the subject area of interest. A process for matching a prospective protégé with a suitable mentor is further described by reference to FIG. 7 below.

The user interface 150 allows a user to interact with the mentor-mentee matching system 100 through the I/O devices 180 or the network 190. Based on data received from the user, the user interface 150 issues a request for a mentor to the mentor selection module 140. The request includes a specification of a subject area of interest. The user interface 150 receives a mentor recommendation (i.e., the suitable mentor identified based on the specified subject area of interest) from the mentor selection module 140 and forwards the recommendation to the user through I/O devices 180 or the network 190.

FIG. 2 illustrates an example content of the collaboration data 115. Collaboration data includes data about one or more prospective mentors over one or more subject areas of expertise that are compiled from raw data collected. In some embodiments, the compiled collaboration data about a subject area of expertise includes statistical data related to longevity of involvement by a prospective mentor in the subject area. The subject area data may include statistical data compiled from one or more collaborative mediums, data such as number of activities attempted and number of activities completed. For each collaborative medium, the collaboration data 115 also includes a task completion ratio (or completion likelihood value) that is derived from the corresponding number of activities attempted and number of activities completed.

As illustrated, the collaboration data 115 includes statistical data related to longevity of involvement by different prospective mentors A, B, and C over different subject areas of expertise. For the prospective mentor A, the collaboration data 115 includes data regarding A′s activities in several different subject areas, subject areas such as “Network QoE”, “Big Data Analysis”, “Disaster recovery”, etc. For each subject area, the collaboration data 115 includes data regarding the prospective mentor A′s involvement over one or more collaborative mediums such as “Research”, “Wiki”, “Blog”, “Web Conference”, “Real Time Chat”, “Social communications”, etc. For each collaborative medium, the collaboration data 115 contains statistics about the prospective mentor's participation in that collaborative medium, i.e., the number of activities attempted and the number of activities completed by the mentor in that collaborative medium, along with a completion of likelihood (i.e., task completion ratio) that is computed from the number of activities attempted and the number of activities completed.

In addition to the statistics regarding the number of activities attempted and completed, the collaboration data 115 also includes a survival quotient for each subject area. In some embodiments, the data aggregation module 120 computes a survival quotient for each prospective mentor in each subject area based on all data collected for that subject area involving the prospective mentor, including the statistics of activity participation over one or more collaborative mediums. As illustrated, the prospective mentor A′s survival quotient (SQ) for the subject area “NetworkQoE” is 0.44, for the subject area “Big Data Analysis” is 0.45, and for the subject area “Disaster Recovery” is 0.19.

FIG. 3 conceptually illustrates computation of survival quotients, consistent with an exemplary embodiment. Survival quotients are periodic (e.g., yearly) roundup values, i.e., a numerical aggregate of the statistics of the tasks or activities that is represented as a single figure. In some embodiments, the survival quotient of a prospective mentor in a particular subject area is computed by aggregating the task attempted numbers and/or task completion numbers for all activities/tasks that are conducted over all collaborative mediums for that particular subject area. As illustrated, the survival quotient of mentor A in subject 1 is an aggregate value based on the attempt/completion data of activities conducted in collaborative mediums 1a, 1b, and 1c, while the survival quotient of mentor B in subject 3 is an aggregate value based on the attempt/completion data of activities conducted in collaborative mediums 3a, and 3c, etc.

In some embodiments, the data aggregation module 120 aggregates the attempt/completion data of a subject area by multiplying the completion likelihood values (task completion ratios) of various collaborative mediums for that subject matter. In the example collaboration data content of FIG. 2, mentor A's SQ for the subject area “NetworkQoE” is 0.44, which is an aggregate value computed by multiplying the completion likelihood numbers of the collaborative mediums “Research” and “Wiki” (0.50 and 0.88 respectively).

The collaboration data is used to predict the longevities of mentoring relationships. For each prospective mentor in each subject area of expertise, the longevity prediction module 130 produces a prediction value for indicating the probability of a mentoring relationship (by the prospective mentor in the subject area) successfully surviving over a period of time in the future. In other words, the prediction value is the predicted survival quotient for the future period. In some embodiments, a prediction value is a combination (e.g., multiplicative product) of the survival quotient and a prediction factor produced by a prediction model.

FIG. 4 illustrates the longevity prediction module 130 using a prediction model 400 to predict the probability of survival for a mentoring relationship. As illustrated, the prediction model 400 receives collaboration data 410 and survival quotient 420 regarding a prospective mentor in a particular subject matter (mentor X and subject i) and produces an output 430 as a prediction factor. The longevity prediction module 130 then combines the survival quotient 420 with the prediction factor 430 to produce a prediction value 440 for the prospective mentor in the particular subject matter. The prediction value 440 is stored in the mentor-expertise database 135, which stores prediction values for different prospective mentors in different subject areas of expertise.

In some embodiments, the prediction model 400 is a linear regression model, i.e., a model that is constructed by performing linear regression over a large set of relevant data, including data on tasks or activities participated by different individuals (may include prospective mentors and individuals who are not prospective mentors) in the different subject areas. The linear regression performed can be logistic regression, dissimilar regression link function, or other types of linear regression functions. In some embodiments, the linear regression model 400 is an equation that makes prediction by using the values of the collaboration data 410 and the survival quotient 420 as parameters. The output of the model (i.e., the prediction factor) is obtained by solving the equation. Equation (1) below is an equation of an example linear regression model that uses collaboration data and survival quotients as input parameters:

log(p/1−p)=2.22−12.45*survival_quotient+0.74*completion_likelihood+0.06*activities_attempted+0.02 activities_completed (1)

In equation (1), the parameter ‘p’ is the prediction factor to be solved. The parameters “survival quotient”, “completion likelihood”, “activities attempted”, and “activities completed” are to be filled with values from the collaboration data and survival quotient. For example, if the number of activities attempted is 50, the number of activities completed is 25, the completion likelihood is 0.50, and the survival quotient is 0.44, then the prediction factor ‘p’ is solved according to:

log(p/1−p)=2.22−12.45*0.44+0.74*0.5+0.06*50+0.02*25 (2)

i.e., the prediction factor ‘p’ is 0.6484. This prediction factor 0.6484 is then multiplied with the survival quotient 0.44 to produce a prediction value 0.29.

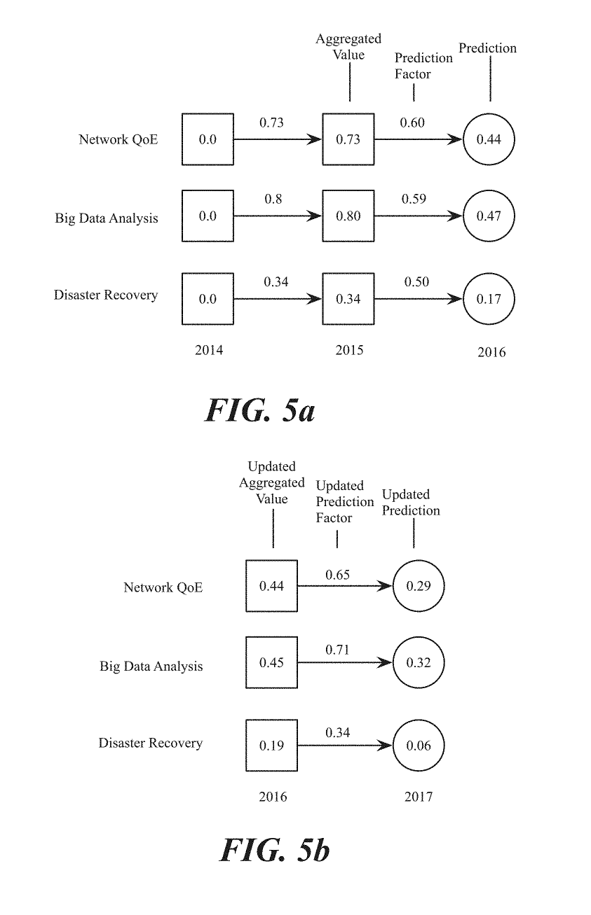

In some embodiments, the mentor-mentee matching system 100 computes a predicted probability (i.e., prediction value) of a future year (or a future time interval) by applying the prediction model on the collaboration data and survival quotient of this year (or a present time interval). The collaboration data and survival quotient of this year may be compiled from raw data of this year or raw data accumulated up to this year. FIGS. 5a-b conceptually illustrates using collaboration data and survival quotient of a present time to predict probability of mentoring relationship survival in the future year. The survival quotient is the aggregated value of the present year and the prediction factor is the output of the prediction model based on collaboration data of the present year. For some embodiments, the predicted probability of the future year is the predicted survival quotient for the future year.

FIG. 5a illustrates the prediction of the probability of mentoring relationship survival for the year 2016 for a particular mentor based on aggregated value of 2015 and prediction factor of the year 2015. As illustrated, the aggregated values for 2015 for the subject areas “Network QoE”, “Big Data Analysis”, and “Disaster Recovery” are respectively 0.73, 0.80, and 0.34. The prediction factors computed based on the collaboration data of 2015 for the three subject areas are respectively 0.60, 0.59, and 0.50. By multiplying the aggregated values of the year 2015 with their corresponding respective prediction factors, the mentor-mentee matching system 100 computes the probabilities of mentoring relationship surviving for the year 2016. Specifically, the probability of relationship survival for the year 2016 in “NetworkQoE” is 0.73×0.60=0.44, the probability of relationship survival in “Big Data Analysis” is 0.80×0.59=0.47, and the probability of relationship survival in “Disaster Recovery” is 0.34×0.50=0.17. These are also the values of the survival quotient predicted for the year 2016.

FIG. 5b illustrates the prediction of the probabilities of continued mentoring relationship survival for the year 2017 based on aggregated values of 2016 and prediction factors calculated based on the year 2016. The prediction for the year 2017 is an updated prediction based on actual data collected for the year 2016, i.e., based on the updated aggregated values of 2016 and updated prediction factors of 2016.

As illustrated, the aggregated value for 2016 for the subject areas “Network QoE”, “Big Data Analysis”, and “Disaster Recovery” are respectively 0.44, 0.45, and 0.19. (These aggregated values are the updated survival quotients of the year 2016 based on actual data collected for 2016, as oppose to the predicted survival quotient for 2016 based on collaboration data of 2015, i.e., 0.44, 0.47, and 0.17 as shown in FIG. 5a.) The prediction factors (output of the prediction model 400) are updated to be 0.65, 0.71, and 0.34 based the collaboration data of the year 2016. By multiplying the updated aggregated values of the year 2016 with their corresponding respective updated prediction factors, the mentor-mentee matching system 100 computes the updated probabilities of relationship survival for the year 2017 to be 0.29, 0.32, and 0.06, respectively.

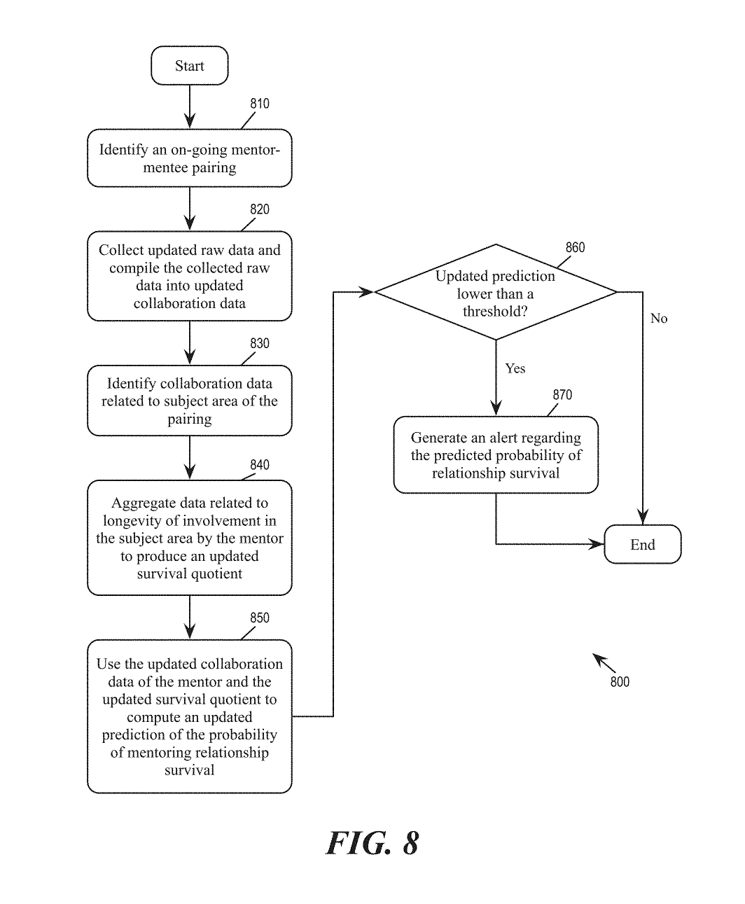

As mentioned, the mentor-mentee matching system also monitors updated collaboration data for mentor-mentee relationship deterioration by re-evaluating survival quotients at regular intervals. In some embodiments, the mentor-mentee matching system issues an alert or a notification whenever the predicted probability of relationship survival falls below certain threshold. For example, the updated prediction value for “Disaster Recovery” 0.06 may fall below such a threshold, and the mentor-mentee matching system would generate an alert to report that a mentoring relationship involving the particular mentor in the subject area “Disaster Recovery” is not likely to survive past the year 2017. FIG. 8 below illustrates a process for monitoring mentor-mentee relationship deterioration by re-evaluating survival quotients at regular intervals.

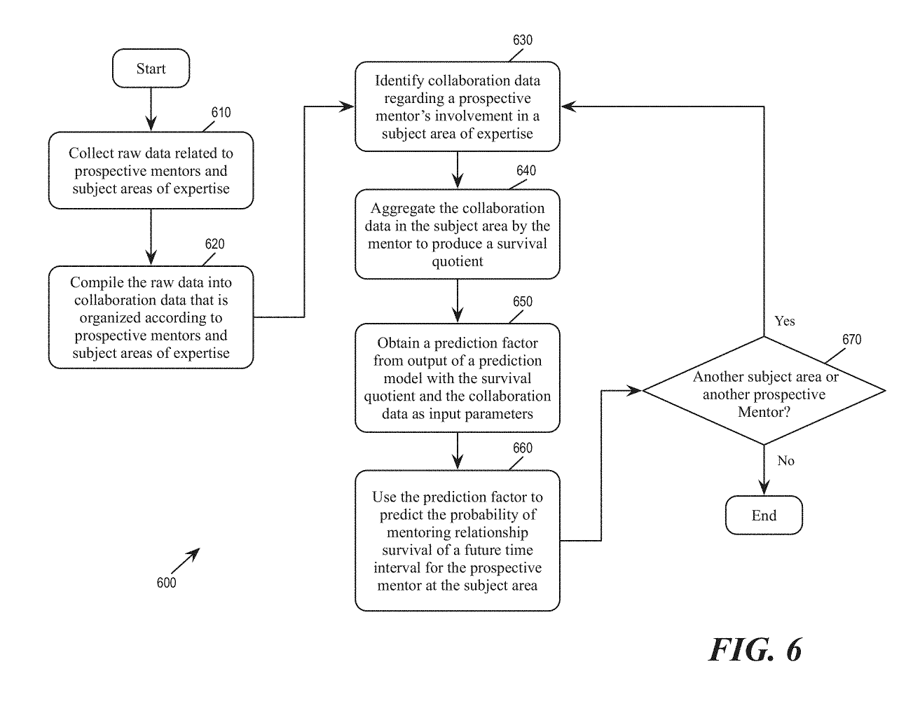

FIG. 6 conceptually illustrates a process 600 for predicting the probability of mentoring relationship survival with respect to subject areas of expertise, consistent with an exemplary embodiment. In some embodiments, one or more processing units (e.g., processor) of a computing device implementing the mentor-mentee matching system 100 (e.g., the computing device 105) perform the process 600.

The matching system starts the process 600 by collecting (at 610) raw data related to prospective mentors and subject areas of expertise. The computing device operating the matching system may receive such data directly from its I/O devices or from the network and/or the Internet. Such data may include various records of activities within the organization that employs the prospective mentors, research papers or patents submitted, and tasks undertaken and completed, etc.

The matching system then compiles (at 620) the collected raw data into collaboration data that is organized according to prospective mentors over various subject areas of expertise. The compiled collaboration data about a subject area of expertise may include data about activities in one or more different collaborative mediums in the subject area, and the data for a collaborative medium of the subject area includes number of activities attempted and number of activities completed. Based on the number of activities attempted and the number of activities completed for a given collaborative medium, the collaboration data also includes a corresponding ratio of completion (or completion likelihood) for the collaborative medium. An example of a compiled collaboration data is illustrated in FIG. 2 above.

To predict the probability of relationship survival for each prospective mentor in each subject area of expertise, the matching system identifies (at 630) collaboration data regarding a prospective mentor's involvement in a subject area of expertise. The system then aggregates (at 640) the collaboration data in the subject area by the mentor to produce a survival quotient, which is a periodic roundup value of the statistics of the tasks or activities. In some embodiments, the survival quotient of a prospective mentor in a particular subject area is computed by aggregating the task attempted and/or task completed numbers for all activities/tasks that are conducted over all collaborative mediums for that particular subject area. In some embodiments, the system computes the survival quotient by multiplying together the completion likelihood of various collaborative mediums for that subject matter. The derivation of survival quotients is described in further detail by reference to FIG. 3 above.

The system then obtains (at 650) a prediction factor for the prospective mentor in the subject area from the output of a prediction model, with the survival quotient and the collaboration data of the prospective mentor in the subject area as input parameters to the prediction model. An example of using a prediction model to derive a prediction factor is described above by reference to Equations (1) and (2). The prediction factor is then used (at 660) to predict the probability of mentoring relationship survival of a future time interval for the prospective mentor at the subject area. In some embodiments, the system multiplies the prediction factor with the survival quotient computed based on the available data of the current time to predict the probability of mentoring relationship survival for the future time period. FIGS. 4 and 5 above illustrate using survival quotients and prediction factors to predict probabilities of mentoring relationship survival.

The system then determines (at 670) whether to predict the probability of relationship survival for another subject area or for another prospective mentor. If so, the process 600 returns to 630. Otherwise the process 600 ends.

FIG. 7 conceptually illustrates a process 700 for matching a mentor with a protégé based on predicted probabilities of relationship survival in different subject areas of expertise, consistent with an exemplary embodiment. In some embodiments, one or more processing units (e.g., processor) of a computing device implementing the mentor-mentee matching system 100 (e.g., the computing device 105) perform the process 700.

The matching system 100 starts the process 700 when it receives (at 710) a request for a mentor. This request is made for a prospective protégé who is interested in a particular subject area of expertise, and the request informs the matching system of the interested subject area.

The matching system receives (at 720) one or more predicted probabilities of relationship survival for one or more prospective mentors in the particular subject area of expertise. The matching system may generate these predicted probabilities of relationship survival for a future time interval by performing the process 600.

The matching system then identifies (at 730) a prospective mentor having a highest predicted survival quotient in the particular subject area for the future time interval. The process 700 then ends.

FIG. 8 conceptually illustrates a process 800 for monitoring mentor-mentee relationship deterioration by re-evaluating survival quotients at regular intervals. In some embodiments, one or more processing units (e.g., processor) of a computing device implementing the mentor-mentee matching system 100 (e.g., the computing device 105) perform the process 800.

The matching system 100 starts the process 800 by identifying (at 810) an on-going pair of mentor and protégé. The matching system then collects (at 820) updated raw data and compiles the collected data into updated collaboration data that are organized according to prospective mentors over various subject areas of expertise. In some embodiments, the updated data collaboration data is organized to have the same categories of statistics, i.e., having fields related to longevity of involvement in one or more collaborative mediums, fields such as number of activities attempted, number of activities completed, completion likelihood, etc.

The matching system then identifies (830) collaboration data related to the subject area of the mentor-mentee pairing. The matching also aggregates (840) data related to longevity of involvement in the subject area to produce an updated survival quotient for the mentor in the subject area, e.g., by multiplying together the completion ratios. The matching system then uses (at 850) the updated collaboration data of the mentor and the updated survival quotient to compute an updated prediction of the probability of mentoring relationship survival into a future time period.

The matching system then determines (at 860) whether the updated prediction of the probability of mentoring relationship is lower than a threshold. The threshold is used to determine whether the updated prediction value indicates that the mentoring relationship has deteriorated below an acceptable level. If the updated prediction value is lower than the threshold (i.e., the mentoring relationship has deteriorated too much), the process 800 proceeds to 870 to generate an alert and ends. Otherwise, the process 800 ends without generating an alert.

### Example Electronic System

The present application may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures (e.g., FIGS. 6, 7, and 8) illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

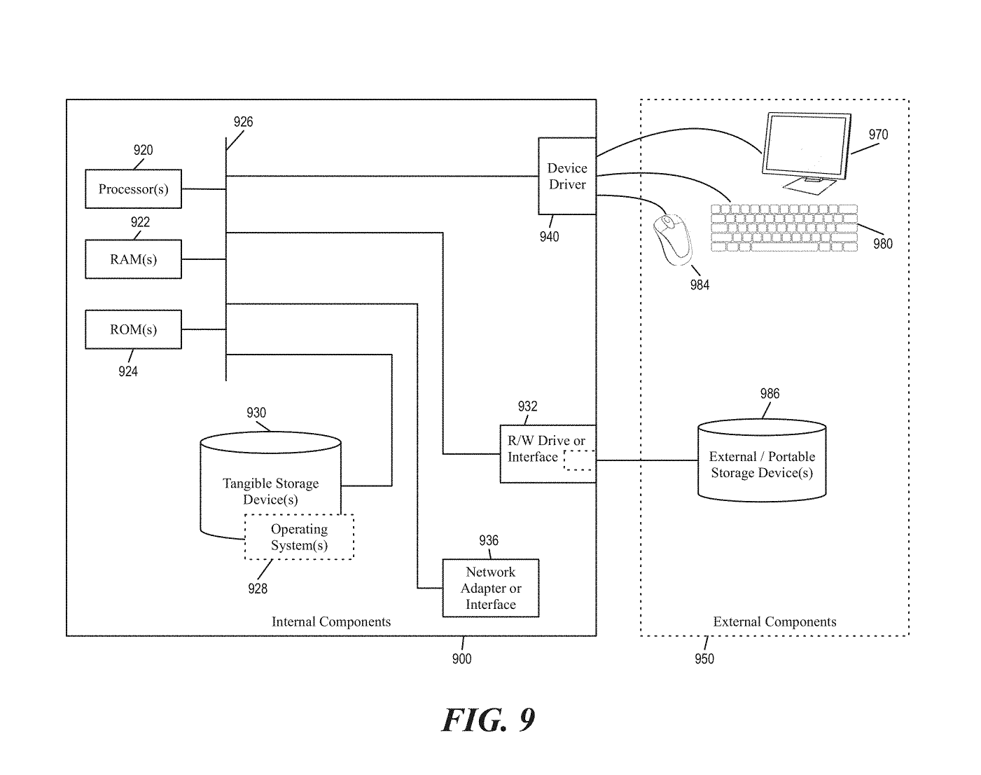

FIG. 9 shows a block diagram of the components of data processing systems 900 and 950 that may be used to implement a system for matching prospective mentors with protégés (i.e., the mentor-mentee matching system 100) in accordance with an illustrative embodiment of the present disclosure. It should be appreciated that FIG. 9 provides only an illustration of one implementation and does not imply any limitations with regard to the environments in which different embodiments may be implemented. Many modifications to the depicted environments may be made based on design and implementation requirements.

Data processing systems 900 and 950 are representative of any electronic device capable of executing machine-readable program instructions. Data processing systems 900 and 950 may be representative of a smart phone, a computer system, PDA, or other electronic devices. Examples of computing systems, environments, and/or configurations that may represented by data processing systems 900 and 950 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The data processing systems 900 and 950 may include a set of internal components 900 and a set of external components 950 illustrated in FIG. 9. The set of internal components 900 includes one or more processors 920, one or more computer-readable RAMs 922 and one or more computer-readable ROMs 924 on one or more buses 926, and one or more operating systems 928 and one or more computer-readable tangible storage devices 930. The one or more operating systems 928 and programs such as the programs for executing the processes 600, 700 and 800 are stored on one or more computer-readable tangible storage devices 930 for execution by one or more processors 920 via one or more RAMs 922 (which typically include cache memory). In the embodiment illustrated in FIG. 9, each of the computer-readable tangible storage devices 930 is a magnetic disk storage device of an internal hard drive. Alternatively, each of the computer-readable tangible storage devices 930 is a semiconductor storage device such as ROM 924, EPROM, flash memory or any other computer-readable tangible storage device that can store a computer program and digital information.

The set of internal components 900 also includes a R/W drive or interface 932 to read from and write to one or more portable computer-readable tangible storage devices 986 such as a CD-ROM, DVD, memory stick, magnetic tape, magnetic disk, optical disk or semiconductor storage device. The instructions for executing the processes 600, 700 and 800 can be stored on one or more of the respective portable computer-readable tangible storage devices 986, read via the respective R/W drive or interface 932 and loaded into the respective hard drive 930.

The set of internal components 900 may also include network adapters (or switch port cards) or interfaces 936 such as a TCP/IP adapter cards, wireless Wi-Fi interface cards, or 3G or 4G wireless interface cards or other wired or wireless communication links. Instructions of processes or programs described above can be downloaded from an external computer (e.g., server) via a network (for example, the Internet, a local area network or other, wide area network) and respective network adapters or interfaces 936. From the network adapters (or switch port adaptors) or interfaces 936, the instructions and data of the described programs or processes are loaded into the respective hard drive 930. The network may comprise copper wires, optical fibers, wireless transmission, routers, firewalls, switches, gateway computers and/or edge servers.

The set of external components 950 can include a computer display monitor 970, a keyboard 980, and a computer mouse 984. The set of external components 950 can also include touch screens, virtual keyboards, touch pads, pointing devices, and other human interface devices. The set of internal components 900 also includes device drivers 940 to interface to computer display monitor 970, keyboard 980 and computer mouse 984. The device drivers 940, R/W drive or interface 932 and network adapter or interface 936 comprise hardware and software (stored in storage device 930 and/or ROM 924).

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Example Characteristics:

On-demand self-service: a cloud consumer can unilaterally provision computing capabilities, such as server time and network storage, as needed—automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Example Service Models:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud-computing environment is service oriented with a focus on statelessness, low coupling, modularity, and semantic interoperability. At the heart of cloud computing is an infrastructure that includes a network of interconnected nodes.

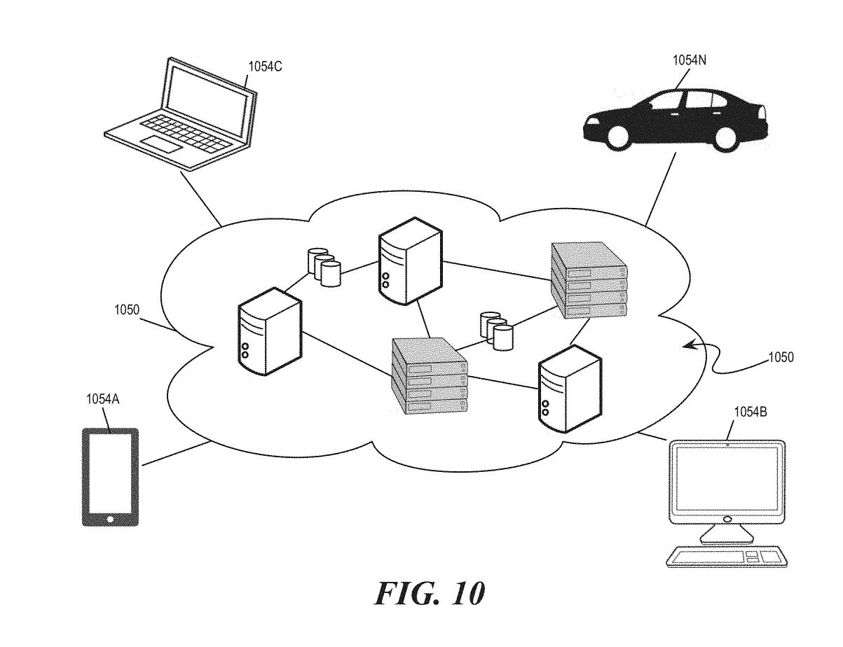

Referring now to FIG. 10, an illustrative cloud computing environment 1050 is depicted. As shown, cloud computing environment 1050 includes one or more cloud computing nodes 1010 with which local computing devices used by cloud consumers, such as, for example, personal digital assistant (PDA) or cellular telephone 1054A, desktop computer 1054B, laptop computer 1054C, and/or automobile computer system 1054N may communicate. Nodes 1010 may communicate with one another. They may be grouped (not shown) physically or virtually, in one or more networks, such as Private, Community, Public, or Hybrid clouds as described hereinabove, or a combination thereof. This allows cloud computing environment 1050 to offer infrastructure, platforms and/or software as services for which a cloud consumer does not need to maintain resources on a local computing device. It is understood that the types of computing devices 1054A-N shown in FIG. 10 are intended to be illustrative only and that computing nodes 1010 and cloud computing environment 1050 can communicate with any type of computerized device over any type of network and/or network addressable connection (e.g., using a web browser).

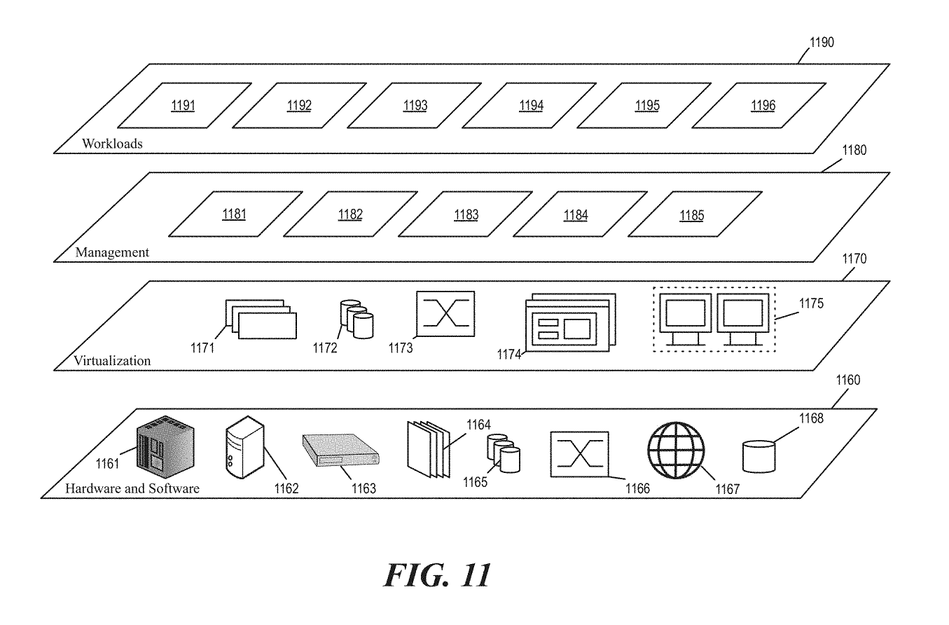

Referring now to FIG. 11, a set of functional abstraction layers provided by cloud computing environment 1050 (of FIG. 10) is shown. It should be understood that the components, layers, and functions shown in FIG. 11 are intended to be illustrative only and embodiments of the disclosure are not limited thereto. As depicted, the following layers and corresponding functions are provided:

Hardware and software layer 1160 includes hardware and software components. Examples of hardware components include: mainframes 1161; RISC (Reduced Instruction Set Computer) architecture based servers 1162; servers 1163; blade servers 1164; storage devices 1165; and networks and networking components 1166. In some embodiments, software components include network application server software 1167 and database software 1168.

Virtualization layer 1170 provides an abstraction layer from which the following examples of virtual entities may be provided: virtual servers 1171; virtual storage 1172; virtual networks 1173, including virtual private networks; virtual applications and operating systems 1174; and virtual clients 1175.

In one example, management layer 1180 may provide the functions described below. Resource provisioning 1181 provides dynamic procurement of computing resources and other resources that are utilized to perform tasks within the cloud computing environment. Metering and Pricing 1182 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1183 provides access to the cloud-computing environment for consumers and system administrators. Service level management 1184 provides cloud computing resource allocation and management such that required service levels are met. Service Level Agreement (SLA) planning and fulfillment 1185 provide pre-arrangement for, and procurement of, cloud computing resources for which a future requirement is anticipated in accordance with an SLA.

Workloads layer 1190 provides examples of functionality for which the cloud computing environment may be utilized. Examples of workloads and functions which may be provided from this layer include: mapping and navigation 1191; software development and lifecycle management 1192; virtual classroom education delivery 1193; data analytics processing 1194; transaction processing 1195; and survival quotient computation 1196. In some embodiments, the workload 1196 performs some of the operations of the mentor-mentee matching system 100.

The foregoing one or more embodiments implements a mentor-protégé matching system within a computer infrastructure by having one or more computing devices collecting and compiling collaboration related data about prospective mentors and their involvement in various subject areas of expertise. The computer infrastructure is further used to aggregate data to produce survival quotients and to use a prediction model to predict the probability of mentoring relationship survival.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving collaboration data about one or more prospective mentors over one or more subject areas;
computing a survival quotient for a prospective mentor in a particular subject area by aggregating data relating to longevity of involvement by the prospective mentor in the particular subject area; and
predicting a probability of mentoring relationship survival for a future time interval for the prospective mentor over the particular subject area based on the received collaboration data and the computed survival quotient.

2. The computer-implemented method of claim 1, wherein the received collaboration data comprises statistical data on longevity of involvement by the prospective mentor in the particular subject area over one or more collaborative mediums.

3. The computer-implemented method of claim 2, wherein the statistical data on longevity of involvement by the prospective mentor in the particular subject area over a collaborative medium comprises a number of activities attempted and a number of activities completed.

4. The computer-implemented method of claim 3, wherein the statistical data on longevity of involvement by the prospective mentor in the particular subject area over a collaborative medium further comprises a task completion ratio that is computed based on the number of activities attempted and the number of activities completed.

5. The computer-implemented method of claim 4, wherein the survival quotient is an aggregate of the task completion ratios for all collaborative mediums of the subject area.

6. The computer-implemented method of claim 1, wherein the predicted probability of mentoring relationship survival is computed by (i) applying a regression model with the collaboration data and the survival quotient of the particular subject area as input parameters and (ii) multiplying an output of the regression model and the survival quotient to obtain the predicted probability of mentoring relationship survival.

7. The computer-implemented method of claim 6, wherein the linear regression model is constructed based on data related to multiple individuals in multiple different subject areas.

8. A computing device comprising:
a network interface;
a set of one or more processing units; and
a storage device storing a set of instructions, wherein an execution of the set of instructions by the set of processing units configures the computing device to perform acts comprising:
receiving raw data from the network interface;
compiling the raw data into collaboration data about one or more prospective mentors over one or more subject areas;
computing a survival quotient for a prospective mentor in a particular subject area by aggregating data relating to longevity of involvement by the prospective mentor in the particular subject area;
predicting a probability of mentoring relationship survival for a future time interval for the prospective mentor over the particular subject area based on the received collaboration data and the computed survival quotient.

9. The computing device of claim 8, wherein the received collaboration data comprises statistical data on longevity of involvement by the prospective mentor in the particular subject area over one or more collaborative mediums.

10. The computing device of claim 9, wherein the statistical data on longevity of involvement by the prospective mentor in the particular subject area over a collaborative medium comprises a number of activities attempted and a number of activities completed.

11. The computing device of claim 10, wherein the statistical data on longevity of involvement by the prospective mentor in the particular subject area over a collaborative medium further comprises a task completion ratio that is computed based on the number of activities attempted and the number of activities completed.

12. The computing device of claim 11, wherein the survival quotient is an aggregate of the task completion ratios for all collaborative mediums of the subject area.

13. The computing device of claim 8, wherein the predicted probability of mentoring relationship survival is computed by (i) applying a regression model with the collaboration data and the survival quotient of the particular subject area as input parameters and (ii) multiplying an output of the regression model and the survival quotient to obtain the predicted probability of mentoring relationship survival.

14. A computer program product comprising:
one or more non-transitory computer-readable storage device and program instructions stored on at least one of the one or more non-transitory storage devices, the program instructions executable by a processor, the program instructions comprising sets of instructions for:
receiving collaboration data about one or more prospective mentors over one or more subject areas;
computing a survival quotient for each of a plurality of prospective mentors in each of a plurality of subject areas;
predicting a probability of mentoring relationship survival for the future time interval for each of the plurality of prospective mentors over each of the plurality of subject areas; and
selecting a mentor from the plurality of prospective mentors based on the predicted probabilities of mentoring relationship survival.

15. The computer program product of claim 14, wherein selecting a mentor comprises receiving a request for a subject area of interest and identifying a mentor having a highest predicted probability of relationship survival for the requested subject area of interest.

16. The computer program product of claim 15, further comprising monitoring for relationship deterioration of the selected mentor by receiving updated collaboration data and computing a updated survival quotient for the selected mentor in the requested subject area of interest to compute a updated predicted probability of relationship survival for a subsequent year.

17. The computer program product of claim 14, wherein the received collaboration data comprises statistical data on longevity of involvement by the prospective mentors in the subject areas over one or more collaborative mediums.

18. The computer program product of claim 17, wherein the statistical data on longevity of involvement by a prospective mentor in a subject area over a collaborative medium comprises a number of activities attempted, a number of activities completed, and a task completion ratio that is computed based on the number of activities attempted and the number of activities completed.

19. The computer program product of claim 18, wherein the survival quotient is an aggregate of the task completion ratios for all collaborative mediums of the subject area.

20. The computer program product of claim 14, wherein predicting the probability of mentoring relationship survival for each prospective mentor comprises: (i) applying a regression model with the collaboration data and the survival quotient of a subject area as input parameters and (ii) multiplying an output of the regression model and the survival quotient to obtain the predicted probability of mentoring relationship survival.
